(19) United States
(12) Patent Application Publication
(10) Pub. No.: US 2015/0125571 A1
(43) Pub. Date: May 7, 2015

(54) FERMENTED DAIRY PRODUCTS CONTAINING SWEETENER AND FLAVOR MODIFIER DERIVED FROM STEVIA AND METHODS OF PRODUCING SAME

(71) Applicant: PURECIRCLE USA INC., Oak Brook, IL (US)

(72) Inventors: Siddhartha PURKAYASTHA, Lombard, IL (US); Avetik MARKOSYAN, Yerevan (AM); Marcia PETIT, Chicago, IL (US); Kristina CHKHAN, Kuala Lumpur (MY); Mariam ADAMYAN, Bandar Enstek (MY)

(21) Appl. No.: 14/494,322

(22) Filed: Sep. 23, 2014

Related U.S. Application Data
(60) Provisional application No. 61/881,030, filed on Sep. 23, 2013.

(51) Int. Cl. A23C 9/13; A23C 9/123

(52) U.S. Cl. CPC A23C 9/1307; A23C 9/123
USPC 426/34; 426/658; 426/580

(57) ABSTRACT

Sweetener compositions including mainly highly purified steviol glycosides, and methods for making and using these compositions as a sweetener to sweeten fermented dairy products, are described.

### BACKGROUND OF THE INVENTION

1. Field of the Invention

The present invention relates generally to sweetener compositions comprising mainly highly purified steviol glycosides and methods for making and using them as a sweetener to sweeten fermented dairy products. In particular, the present invention relates to different sweetener compositions derived from stevia extracts comprising non-caloric or low-caloric natural high-potency sweetener and glucosylated steviol glycosides as a flavor modifier. The present invention also relates to sweetener compositions and method to incorporate the sweetener in dairy application that can improve the taste of the reduced sugar dairy products by imparting a more sugar-like taste or characteristic. In particular, the sweetener compositions and methods provide a more sugar-like temporal profile in dairy applications.

2. Description of the Related Art

Nowadays sugar alternatives are receiving increasing attention due to awareness of many diseases in conjunction with consumption of high-calorie foods and beverages. Consumers are also looking for natural ingredients in their food and beverages, thus non-caloric sweeteners of natural origin are becoming increasingly popular. The sweet herb Stevia Rebaudiana Bertoni produces a number of diterpene glycosides which feature high intensity sweetness and sensory properties superior to those of many other high potency sweeteners.

The above-mentioned sweet glycosides, have a common aglycon, steviol, and differ by the number and type of carbohydrate residues at the C13 and C19 positions. The leaves of Stevia are able to accumulate up to 10-20% (on dry weight basis) steviol glycosides. The major glycosides found in Stevia leaves are Rebaudioside A (2-10%), stevioside (2-10%), and Rebaudioside C (1-2%). Other glycosides such as Rebaudioside B, D, E, and F, M (Reb X), steviolbioside and rubusoside are found at much lower levels (approx. 0-0.2%).

Steviol glycosides differ from each other not only by molecular structure, but also by their sweetness intensity and taste quality or properties as shown in the Table 1 (Reference: PCT/US2012/030210).

TABLE 1
Steviol Glycoside Molecules and their sweetening

| | | | Sweetening power | |
|---|---|---|---|---|
| Steviol glycosides | R1 (C-19) | R2 (C-13) | relative to sucrose | Taste Quality |
| Stevioside (G3) | β-Glc | β-Glc-β-Glc(2-1) | 150-300 | 0 |
| Rebaudioside A (G4) | β-Glc | β-Glc-β-Glc(2-1)- | 200-400 | +2 |
| | | β-Glc(3-1) | | |
| Rebaudioside B (G3) | H | β-Glc-β-Glc(2-1)- | 300-350^{a} | 0 |
| | | β-Glc(3-1) | | |
| Rebaudioside C (G4) | β-Glc | β-Glc-α-Rha(2-1)- | 50-120 | −1 |
| | | β-Glc(3-1) | | |
| Rebaudioside D (G5) | β-Glc-β-Glc(2-1) | β-Glc-β-Glc(2-1)- | 200-300 | +3 |
| | | β-Glc(3-1) | | |
| Rebaudioside E (G4) | β-Glc-β-Glc(2-1) | β-Glc-β-Glc(2-1) | 250-300 | +1 |
| Rebaudioside F (G4) | β-Glc | β-Glc-β-Xyl(2-1)- | Na | Na |
| | | β-Glc(3-1) | | |
| Rubusoside(G2) | β-Glc | β-Glc | 110 | −2 |
| Steviolmonoside(G1) | H | β-Glc | Na | Na |
| Steviolbioside(G2) | H | β-Glc-β-Glc(2-1) | 100-125 | −3 |
| DulcosideA (G3) | β-Glc | β-Glc-α-Rha(2-1) | 50-120 | −2 |

*G# means number of carbohydrate residue (mainly glucose)

However, even in a highly purified state, steviol glycosides still possess undesirable taste attributes such as bitterness, sweet aftertaste, licorice flavor, etc. One of the main obstacles for the successful commercialization of stevia sweeteners are these undesirable taste attributes. It was shown that these flavor notes become more prominent as the concentration of steviol glycosides increases (Prakash I., DuBois G. E., Clos J. F., Wilkens K. L., Fosdick L. E. (2008) Development of Rebiana, a natural, non-caloric sweetener. Food Chem. Toxicol., 46, S75-S82.).

The glucosylated steviol glycosides (GSG) can be made by attaching additional glucose units to steviol glycoside molecules by selected enzyme(s). The GSG molecules show improved sweetness profile with significant improvement of non-sweet taste (U.S. Pat. Nos. 4,219,571, 7,838,044, and 7,807,206). Depending on the degree of glucosylation (number of glucose units added), the sweetness intensity can be significantly reduced and GSG can act as a flavor modifier and enhances sweetness profile (Glucosylated Steviol Glycosides as flavor modifiers, US Patent application, PCT/US2011/033737, FEMA GRAS 26, FEMA#4728).

If the taste profile of high-potency sweeteners (HPS) could be modified to impart desired taste characteristics, it can contribute to taste characteristics in low calorie food products that are more desirable for consumers. This invention combines different natural sweeteners, especially Stevia sweeteners in certain proportion to provide better and rounded sweetness profile with limited non-sweet taste profile. This invention also show that when blend of such sweeteners is combined with very small amount of GSG, which acts as a flavor modifier, an unexpectedly rich and rounded sweetness profile is achieved in food applications, particularly in fermented dairy products like yogurt.

Yogurt is made from milk and bacterial culture added with sugars, stabilizers, fruits and flavors. The commercial manufacturing process includes standardizing (modifying) the composition of and pasteurizing the milk; fermenting at warm temperatures; cooling to develop structure (white mass); stirring the white mass and adding fruit, sugar and other ingredients. Raw milk composition is standardized to get total solid content around 16% with 1-5% fat and 11-14% solids-not-fat (SNF). The compositional goal is achieved by removing milk fat and either by evaporating excess water or by adding milk solid or concentrated milk. After standardization, stabilizers are added and milk is pasteurized, which involves heating the milk to a relatively high temperature and holding it there for a set amount of time. The milk is then homogenized to break the fat globules to smaller size and then cooled down to 43-46° C. before adding fermentation culture. The inoculated milk is held at warm temperature for several hours to reach desired lactic acid level with minimum acidity of 0.9% and pH about 4.4. The yogurt is cooled to achieve the firmer texture. For flavored yogurt, flavors, fruit prep or sweeteners are added to prepared yogurt mixing thoroughly, then packaged and stored in refrigerated temperature.

Yogurts with different flavors and fruit puree have become very popular, where such additives have more than 50% sugar in them. With the trend toward healthy eating, many manufacturers offer a low sugar and low fat version of yogurts. Low or no sugar yogurts are often sweetened with aspartame. With ever-increasing market-demand for natural ingredients in food, stevia sweeteners are deemed to be perfect solution, if stevia could deliver the sugar-like taste that consumers expect in fermented dairy products like yogurt.

Prakash et al (Food Chem Toxicol, 56, 2008) reported that stevia sweetener (Rebiana or Reb A) was stable during the processing and storage of yogurt. The publication states that “no significant loss (of stevia sweetener) was measured during pasteurization (190° F. for 5 min) and fermentation (for making plain yogurt). Rebiana was stable throughout a 6-week storage period (40° F.)”. The main challenge with the stevia sweeteners like Reb A in yogurt application is that it modifies the flavor and acidity profile and leave non-sweet taste of stevia in fermented dairy products. Additionally, the sweetness profile of yogurt product with stevia sweetener may change and provide impression of less sweetness after certain period of shelf life.

This innovation, in part, pertains to the formulation of the fermented milk products sweetened with specific blends of natural sweeteners and flavors derived from stevia extract. The innovation, in part, also pertains to the formulation of the fermented mil products containing a buffering agent that surprisingly provides the smooth and rounded sweetness profile in fermented milk products sweetened with stevia sweeteners. This innovation, in part, pertains to the process to prepare fermented milk products sweetened with stevia sweetener, where addition of sweetener during the process is critical to achieve the desired taste and sweetness profile. This innovation, in part, also pertains to the process to prepare fermented milk products sweetened with stevia sweetener, where addition of sweetener during the process is critical to achieve the consistent taste and sweetness profile over the shelf life.

### SUMMARY OF THE INVENTION

The present invention is aimed to overcome the disadvantages of existing Stevia sweeteners in fermented dairy formulation. The present invention is directed to a taste and flavor profile improving composition. The invention describes blends of selected steviol glycosides at a certain ratios for producing a high purity food ingredient from the extract of the Stevia Rebaudiana Bertoni plant and use thereof in various fermented or cultured dairy products as a sweetness and flavor modifier. Non-limiting examples of fermented or cultured dairy products include cheese, yogurt, yogurt drink, acidophilus milk, sour crème, buttermilk, lassi, kefir, kumis, viili, filmjolk, crème cheese, amasi, leben, calpis, smetana, ayran, clabber, dadhia, and other similar cultured dairy products.

The invention, in part, pertains to an ingredient comprising steviol glycosides of Stevia Rebaudiana Bertoni plant. The steviol glycosides are selected from the group consisting of stevioside, Rebaudioside A, Rebaudioside B, Rebaudioside C, Rebaudioside D, Rebaudioside E, Rebaudioside F, dulcoside A, steviolbioside, rubusoside, as well as other steviol glycosides found in Stevia Rebaudiana Bertoni plant and mixtures thereof. In addition, the invention pertains to an ingredient comprising steviol glycosides and glucosylated steviol glycosides to impart superior taste and flavor profile in cultured dairy products.

The invention also pertains to an ingredient comprising stevia derived sweeteners and phosphate salt of sodium or calcium ion, especially mono-sodium phosphate that is known to act as a buffering agent in different food and beverage. However, the mono-sodium phosphate salt is surprisingly discovered to modify the sweetness profile in the fermented dairy product sweetened with stevia sweetener.

The invention also directed to a process of incorporating sweetener composition during the making of yogurt. The sweetener and flavor are generally added to the white mass after the fermentation of the milk. Those skilled in the art would assume that the change of the order of addition of sweetener during the manufacturing process would have no effect on the final product. However we surprisingly discovered that unlike to common belief, the introduction of stevia sweetener prior to fermentation yield a product completely different in taste profile. Additionally, we discovered that the introduction of stevia sweetener prior to fermentation yield a product with consistent sweetness profile over the typical shelf life of the yogurt.

Within the description of this invention we will show that, when certain blend of steviol glycosides are added to sweeten the yogurt before fermentation rather after fermentation, the sweetness profile improves significantly and remains consistent over the shelf life.

This invention will also show the method of combining stevia-derived sweeteners and flavor modifier such as GSG in no-added sugar yogurt applications contribute superior taste profile.

### BRIEF DESCRIPTION OF THE DRAWINGS

FIG. 1 is a graph showing the effect of sweeteners on yogurt sensory profile.

FIG. 2 is a graph showing the results of an evaluation of a white mass made with sugar.

FIG. 3 is a graph showing the results of an evaluation of a white mass made with Alpha/SG-95.

FIG. 4 is a graph showing the results of an evaluation the sweet aftertaste of a white mass made with SG-95 and Alpha.

FIG. 5 is a graph showing the results of an evaluation of the sweet aftertaste of a white mass made with SG-95 and NSF-02.

FIG. 6 is a graph showing the results of an evaluation of the sweetness intensity of a white mass made with Alpha and SG-95.

FIG. 7 is a graph showing the results of an evaluation of the sweetness intensity of a white mass made with SG-95 and NSF-02.

### EXAMPLE 1

### Preparation of White Mass (Yogurt)

Milk was brought to boil and stevia ingredient or sugar (Table 2) was dissolved in a measured quantity of milk as it was cooling down. The milk was cooled down to 37 C and monosodium phosphate was added (46 mg per 100 ml of milk). Adequate amount (5-10 g/100 ml) of starter (yogurt culture) was added with moderate stirring and then the mixture was kept in the incubator at 37 C for 16 hours. The white mass is then kept at a refrigerated temperature (4 C) for 24 hours and served cold for tasting.

TABLE 2
Sweetener and flavor modifier used for making the white mass

| Sweeteners/ | Mfg. | Description of the sweeteners |
|---|---|---|
| Flavors | Company | and flavor modifier* |
| Sugar | Domino | Cane sugar granulated |
| Reb A 97 | PureCircle | Highly purified Rebaudioside A, purity >97%, |
| | | Stevia extract |
| SG95 | PureCircle | Blend of steviol glycosides extracted from |
| | | stevia leaf Purity >95%; Reb A content >50% |
| PC Alpha | PureCircle | Proprietary blend of steviol glycosides; Reb |
| | | A content >75% |
| NSF02 | PureCircle | Glucosylated steviol glycosides (GSG), a |
| | | flavor modifier |

*All stevia sweeteners meet JECFA (2010) spec; NSF02 is a natural flavor complex derived from stevia extract

Initial white mass samples were made with two commercial starters (Stonyfield Farm and Dannon) and a small group of panel members tasted both samples. Panel preferred the white mass made with Stonyfield Farm culture, which gave white mass with smooth texture, less acid and slightly sweeter taste.

### EXAMPLE 2

### Effect of Phosphate Salt on Sensory Attributes

To determine the effect of mono-sodium phosphate on the taste and texture of white mass, test samples were prepared using the methodology outlined in example 1 with and without monosodium phosphate and sweetened with SG95 and NSF02 (a flavor modifier) combination. The control sample contained sugar and monosodium phosphate. Table 3 shows the sweetener amount in the samples and lists the comments from a trained sensory panel of 5 members. The monosodium phosphate provided buffering of acid profile and contributed some smoothness of texture, as expected. However, the enhancement of sweetness by the interaction of phosphate salt with stevia sweetener was an unexpected outcome in the formulation.

TABLE 3
Effect of mono-sodium phosphate with stevia sweetener
on sensory attributes of white mass.

| | Sugar | SG95 | NSF02 | Phosphate | |
|---|---|---|---|---|---|
| | (%) | (ppm) | (ppm) | (ppm) | Sensory Comments |
| Control | 8 | | | 458 | More Sour, more |
| | | | | | lactic acid |
| Sample 1 | | 627 | 125 | 458 | Sweeter than control, |
| | | | | | smoother, slight |
| | | | | | bitter, off note |
| Sample 2 | | 627 | 125 | | Less sweet, Harsh, |
| | | | | | high lactic, high dairy |
| | | | | | note, sour milk taste |

### EXAMPLE 3

### Formulation with Different Combination of Sweeteners Added Before Incubation

The white mass samples containing different sweetener system (Table 4) were prepared by the methodology outline in Example 1. The refrigerated samples were tested by a trained sensory panel to investigate the effect of sweeteners on the taste of the white mass.

TABLE 4
Effect of sweeteners on the sensory profile of white mass

| | Sugar | | | Alpha + | SG95 + |
|---|---|---|---|---|---|
| | Control | Reb A | Alpha | SG95 | NSF02 |
| | Test No. | | | | |
| Ingredients (g) | C | 1 | 2 | 3 | 4 |
| Sugar | 28 | | | | |
| Alpha | | | 0.152 | 0.33 | |
| SG95 | | | | 0.22 | 0.175 |
| Reb A | | 0.152 | | | |
| NSF02 | | | | | 0.0437 |
| Whole milk | 332.5 | 360.35 | 360.35 | 1132.45 | 360.28 |
| Total (g) | 360.5 | 360.5 | 360.5 | 1133 | 360.5 |

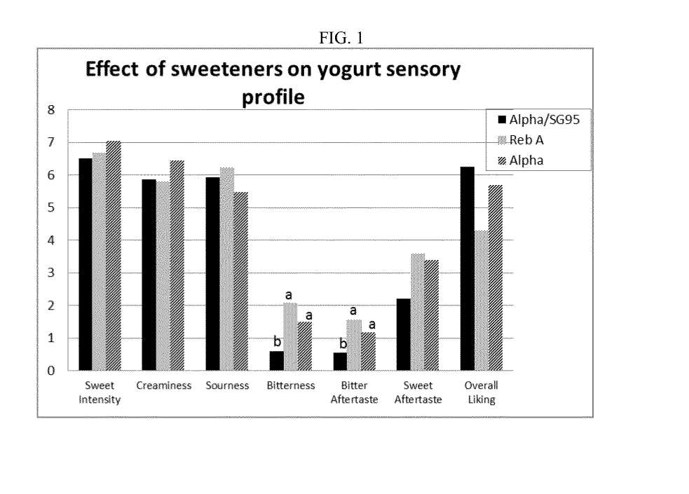

The sensory panel of 8 members found the sweetness profile of the white mass is much more rounded for the SG95/Alpha (Test 3) blend than Reb A and Alpha sweetened samples. The panel found significant improvement of bitter and bitter aftertaste with the blend of SG95/Alpha sweeteners compared to Reb A and Alpha. The panel also found the overall liking and sweet aftertaste improved in Test 3 as show in FIG. 1.

### EXAMPLE 4

### Effect of the Addition of Sweeteners During the Preparation of Yogurt

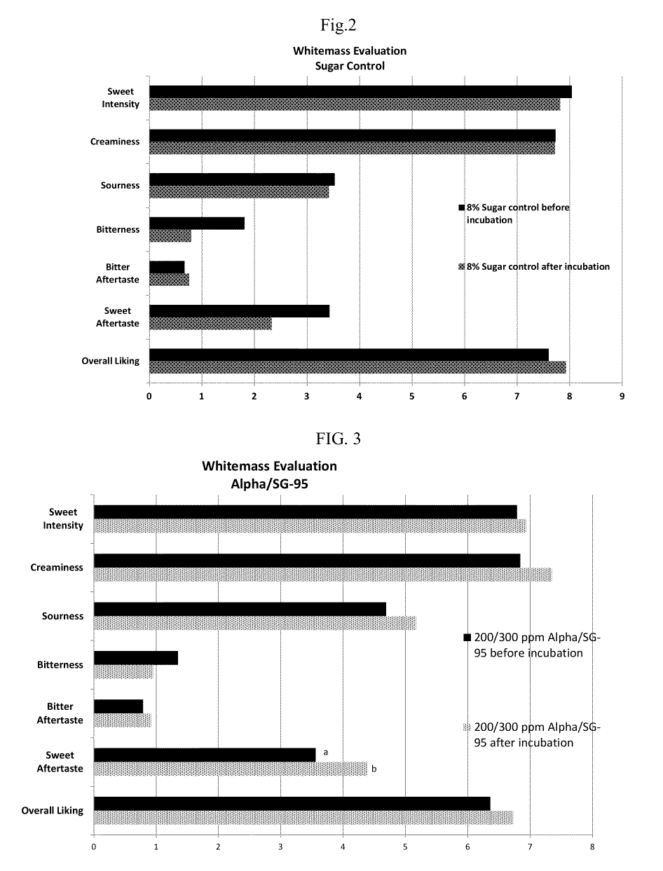

To determine the effect of addition of sweeteners before and after incubation, white mass samples were made using the methodology outlined in Example 1. The sweeteners tested were sugar and a blend of Alpha and SG95 as outlined in Table 5. A sensory panel of 8 members evaluated those samples for sweet intensity, sourness, creaminess, bitterness, bitter aftertaste, sweet aftertaste and overall liking as shown in FIG. 2 and FIG. 3.

TABLE 5
Effect of the addition of sweeteners during
the preparation of the white mass

| | |
|---|---|
| Sugar | Alpha + |
| Control | SG95 |

Test Number

| Ingredients (g) | C | 3 |
|---|---|---|
| Sugar | 28 | |
| Alpha | | 0.105 |
| SG95 | | 0.07 |
| Reb A | | |
| NSF02 | | |
| Whole milk | 332.5 | 360.33 |
| Total (g) | 360.5 | 360.5 |

### Results:

Stevia added before incubation had lower sweet aftertaste compare to sample when stevia was added after incubation.
Control sample of sugar added before and after incubation did not show any significant difference in attributes

### EXAMPLE 5

### Effect of the Addition of Sweeteners and Flavors During the Preparation of Yogurt

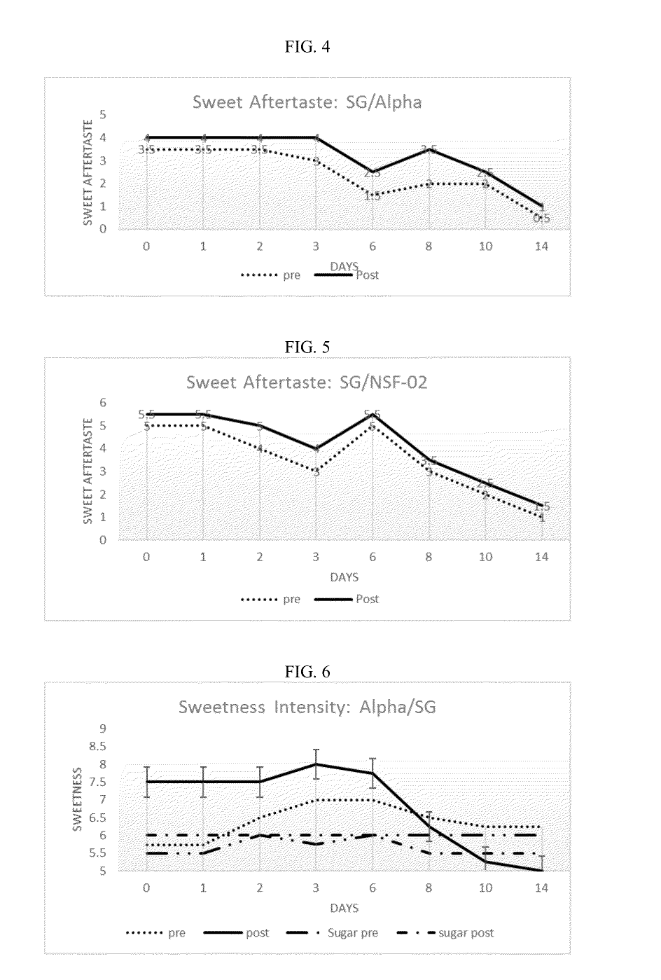

To determine the effect of addition of sweeteners and flavors before and after incubation, white mass samples were made using the methodology outlined in Example 1. The sweeteners tested were sugar and a blend of Alpha, SG95 and NSF-02 as outlined in Table 6. A sensory panel of 4 members evaluated those samples for sweet aftertaste as shown in FIG. 4, and FIG. 5.

TABLE 6
Effect of the addition of sweeteners and flavor
during the preparation of the white mass

| | Formulation | | |
|---|---|---|---|
| | | NAS Stevia | NAS Stevia |
| | Target | sweetened | sweetened |
| | Original | SG95/Alpha | SG95/NSF-02 |
| Milk 3.5% Fat | 85 | 88 | 88 |
| Natural Yoghurt | 5 | 5 | 5 |
| Sucrose | 5 | 0 | 0 |
| SMP | 3 | 5 | 5 |
| Double Cream | 2 | 2 | 2 |
| SG95 | — | 0.08 | 0.023 |
| Alpha | — | 0.16 | — |
| NSF-02 | — | — | 0.0125 |
| Total | 100 | 100 | 100 |

### Results:

The addition of stevia or stevia and flavor before incubation had a lower sweet-aftertaste compare to sample when stevia or stevia and flavor was added after incubation.
The sweet-aftertaste consistently decreased over the shelf life of 2 weeks.

### EXAMPLE 6

### Effect of the Addition of Sweeteners and Flavors During the Preparation of Yogurt on Sweetness Over Shelf-Life

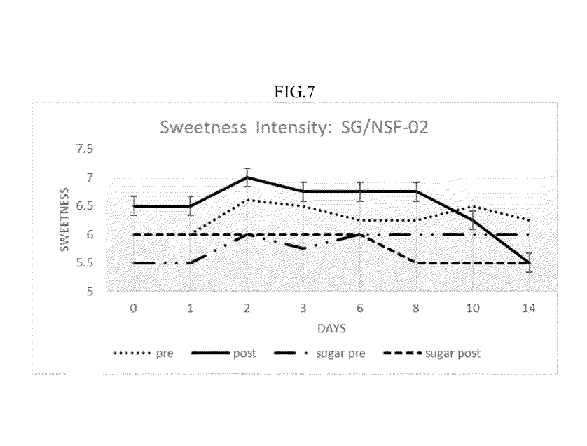

To determine the effect of the addition of sweeteners and flavors before and after incubation on sweetness during shelf-life, white mass samples were made using the methodology outlined in Example 1. The sweeteners tested were sugar and a blend of Alpha, SG95 and NSF-02 as outlined in Table 6. A sensory panel of 4 members evaluated those samples for sweet intensity, and sweet aftertaste as shown in FIG. 6 and FIG. 7.

### Results:

The control samples (with sugar) showed no change in the sweetness perception over the shelf life of 14 days
The addition of stevia sweetener combination or the combination stevia sweetener and flavor (GSG) before incubation provided consistent sweetness profile over 14 days. The variation is within the experimental variation.
The addition of stevia sweetener combination or the combination of stevia sweetener and flavor (GSG) after incubation provided steadily decreasing sweetness perception after 6-8 days of shelf life.
The addition of the selected stevia sweetener blend or the blend of sweetener and flavor (GSG) before incubation had a lower sweet aftertaste during a 14 day period of time compared to sample when those blends were added after incubation.
The addition of stevia sweetener blend or the blend of sweetener and flavor (GSG) before incubation had a higher sweet intensity after 14 days compared to samples when when those blends were added after incubation.

1. A blend of natural sweetener composition derived from stevia extract and a phosphate salt provide superior taste and sweetness profile in fermented dairy product.

2. The natural sweetener composition of claim 1, wherein said purified Stevia extract comprises a blend of steviol glycosides with Reb A content more than 50% and less than 95%, more specifically between 60 and 90% of total steviol glycosides present in the sweetener.

3. The natural sweetener composition of claim 2, wherein said other steviol glycosides are less than 50 percent of a blend of primarily Reb B, Reb D, Reb C and other steviol glycosides.

4. The natural sweetener composition of claim 1, wherein the phosphate salts, especially mono-sodium phosphate is used as the sweetness profile modifier.

5. The natural sweetener composition of claim 1, wherein glucosylated steviol glycoside is used as a flavor modifier, where the concentration of GSG is between 10 to 500 ppm, more specifically between 50 and 300 ppm in the final product.

6. The natural sweetener composition that consists of the sweetener of claim 1 and natural flavor of claim 5 to provide better sweetness and aftertaste in dairy products.

7. The process for the preparation of a natural sweetener composition, which comprising the steps of formulating a natural sweetener composition; dry mixing the natural sweetener composition; granulated or agglomerated to a certain particle size distribution;

8. A process of making yogurt, where in the sweetener composition of claim 1 is added before incubation rather after fermentation and setting of the yogurt.

9. The dairy product made with sweetener composition of claim 2 with process condition of claim 2 results in better and consistent sweetness and reduced sweetness aftertaste.

10. The dairy product made with sweetener composition of claim 2 with process condition of claim 9 results in better and consistent sweetness and reduced sweetness aftertaste in dairy product.
